(19) United States
(12) Patent Application Publication
(10) Pub. No.: US 2009/0060525 A1
(43) Pub. Date: Mar. 5, 2009

(54) ALL-OPTICAL POLARIZATION-INDEPENDENT CLOCK RECOVERY

(75) Inventor: Tuomo Von Lerber, Helsinki (FI)

Correspondence Address: VENABLE LLP, P.O. BOX 34385, WASHINGTON, DC, 20043-9998, US

(73) Assignee: LUXDYNE OY, Helsinki (FI)

(21) Appl. No.: 12/280,576

(22) PCT Filed: Feb. 24, 2006
(86) PCT No.: PCT/FI06/50079

§ 371 Date: Aug. 25, 2008

(51) Int. Cl. H04B 10/00

(52) U.S. Cl. 398/155

(57) ABSTRACT

Simultaneous recovery of several different clock signals is based on coupling an optical input signal into an optical resonator matched with at least four spectral peaks of the input signal. The input signal having arbitrary polarization is divided by a polarizing splitter into a first signal having horizontal polarization and a second signal having vertical polarization. The polarization of the first signal is rotated 90 degrees such that the polarization of the first signal is parallel to the vertical polarization second signal. Both vertically polarized signals are passed through the same optical resonator in opposite directions, and they are combined after passing through the resonator in order to form an output signal. The spectral separation between the first peak and the second peak is equal to a first clock frequency, and the spectral separation between the third peak and the fourth peak is equal to a second clock frequency. The resonator stores optical energy and provides an output also when the input signal is zero. Thus, the output signal includes a first recovered clock signal which exhibits continuous beat at the first clock frequency, and a second recovered clock signal which exhibits continuous beat at the first clock frequency. Only vertically polarized light is passed through the resonator. Thus, variations in the polarization of the input signal do not require continuous re-adjustment of the resonator.

The present invention relates to the recovery of clock signals in optical communication systems.

### BACKGROUND OF THE INVENTION

Optical clock recovery is needed e.g. to synchronize receivers with transmitters in optical communication systems, especially in all-optical systems having modulation frequencies in the order of 10 GHz or higher.

When an optical resonator is matched with a spectral peak of a signal, it is capable of storing optical energy associated with the frequency of said spectral peak. Consequently, the optical resonator may provide continuous optical output also during periods when the input signal is at the zero level.

An optical resonator may be matched with the carrier frequency and the sideband frequency of an optical data signal such that the spectral separation between said frequencies is equal to the clock frequency associated with the data signal. In that case the output of the optical resonator exhibits a continuous beat at the clock frequency, i.e. the clock signal may be recovered.

The article “Optical Tank Circuits Used for All-Optical Timing Recovery”, by M. Jinno and T. Matsumoto, IEEE Journal of Quantum Electronics Vol. 28, No. 4 April 1992, pp. 895-900, discloses a method for optical clock recovery. An optical clock signal synchronized to an incoming data stream is generated by extracting line spectral components in the incoming data stream using an optical resonator whose free spectral range is equal to the incoming data bit rate.

The polarization of light transmitted through an optical resonator may affect the spectral position of the resonator. Thus, stabilizing means may be needed when the polarization of the optical signal varies or is unknown.

U.S. Pat. No. 6,954,559 discloses a regenerator for an optical clock signal comprising a mode-locked semiconductor laser. The re-generator has a light splitter for splitting an optical input signal into two parts, which have polarizations different by 90 degrees. The first part is coupled to a first end face of the semiconductor laser. The second part is rotated 90 degrees by a rotator and coupled to the other end face of the semiconductor laser. The semiconductor laser provides a sequence of clock pulses corresponding to the clock frequency of the input signal.

### SUMMARY OF THE INVENTION

The object of the present invention is to provide a method for the simultaneous optical recovery of a plurality of clock frequencies. The object of the invention is also to provide an optical clock recovery device for the simultaneous recovery of a plurality of clock frequencies. Yet, the object of the invention is to provide a communication system comprising said clock recovery device.

According to a first aspect of the invention, there is a method of recovering two or more optical clock signals from an optical input signal, said input signal comprising two or more spectrally separate data signals, said method comprising:
dividing said input signal into a first polarized signal and a second polarized signal, the initial polarization state of said first polarized signal being different from the initial polarization state of said second polarized signal,
altering the polarization state of one or both of said first and second polarized signals such that the polarization state of said first polarized signal becomes the same as the polarization state of said second polarized signal,
directing the first polarized signal and the second polarized signal after said altering of the polarization state or states to pass through one or more optical resonators in opposite directions, said one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal, and
combining said first polarized signal and said second polarized signal after passing through said one or more optical resonators in order to form an output signal comprising a first recovered clock signal having said first clock frequency and a second recovered clock signal having said second clock frequency.

According to a second aspect of the invention, there is a clock recovery device for recovering two or more clock signals from an optical input signal, said input signal comprising two or more spectrally separate data signals,

said clock recovery device comprising:
a polarizing splitter to divide an input signal into a first polarized signal and a second polarized signal, the initial polarization state of said first polarized signal being different from the initial polarization state of said second polarized signal,
one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal,
one or more polarization altering means to alter the polarization state of one or both of said polarized signals such that the polarization state of said first polarized signal becomes the same as the polarization state of said second polarized signal, said first and second polarized signals being, after said altering of the polarization state or states, adapted to pass through said one or more optical resonators in opposite directions, and
a combiner to combine said first signal and said second signal after passing through said one or more optical resonators in order to form an output signal comprising a first recovered clock signal having said first clock frequency and a second recovered clock signal having said second clock frequency.

According to a third aspect of the invention, there is an optical communication system comprising:
transmitting means adapted to send an optical input signal, said input signal comprising two or more spectrally separate data signals,
a transmission path,
receiving means, and
a clock recovery device to recover at least two clock signals from said optical input signal,
   said clock recovery device comprising:
a polarizing splitter to divide an input signal into a first polarized signal and a second polarized signal, the initial polarization state of said first polarized signal being different from the initial polarization state of said second polarized signal,
one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal,
one or more polarization altering means to alter the polarization state of one or both of said polarized signals such that the polarization state of said first polarized signal becomes the same as the polarization state of said second polarized signal, said first and second polarized signals being, after said altering of the polarization state or states, adapted to pass through said one or more optical resonators in opposite directions, and
a combiner to combine said first signal and said second signal after passing through said one or more optical resonators in order to form an output signal comprising a first recovered clock signal having said first clock frequency and a second recovered clock signal having said second clock frequency.

According to a fourth aspect of the invention, there is a method of recovering two or more optical clock signals from an optical input signal, said input signal comprising several spectrally separate data signals,

said method comprising:
dividing said input signal into a first polarized signal and a second polarized signal, the initial polarization state of said first polarized signal being different from the initial polarization state of said second polarized signal,
altering the polarization state of one or both of said first and second polarized signals such that the polarization state of said first polarized signal becomes the same as the polarization state of said second polarized signal,
directing said first polarized signal and said second polarized signal after said altering of the polarization state or states to pass through one or more optical resonators in opposite directions, said one or more optical resonators having passbands, a first passband being matched with a first spectral peak of said input signal, and a second passband being matched with a second spectral peak of said input signal,
combining said first polarized signal and said second polarized signal after passing through said one or more optical resonators in order to form an output signal,
combining said output signal with auxiliary light having a third spectral peak and a fourth spectral peak such that a first clock signal and a second clock signal are formed, the spectral separation between said first spectral peak and said third spectral peak being equal to a first clock frequency associated with said input signal, and the spectral separation between said second spectral peak and said fourth spectral peak being equal to a second clock frequency associated with said input signal.

In order to eliminate the polarization dependence of the optical resonators and/or other components of the device, the optical input signal having an arbitrary and/or random polarization state is divided into a first signal and a second signal. The initial polarization state of the first signal is different from the initial polarization state of the second signal, e.g. the first signal may be horizontally polarized and the second signal may be vertically polarized. The polarization state of one or both of the polarized signals is altered such that the polarization state of the first signal becomes the same as the polarization state of the second signal. Subsequently, the signals having the same polarization state are passed through the optical resonator in opposite directions, and further combined to form the output signal.

Only light having a predetermined polarization state is passed through the optical resonators. Thus, variations in the polarization of the input signal do not require re-adjustment of the resonators or other components of the clock recovery device. Consequently, the system is simpler and more reliable.

The optical resonators of the clock recovery device are selected such that clock signals associated with several spectrally separate data signals may be recovered simultaneously by using only one clock recovery device. The number of the recovered clock signals may be substantially greater than the number of the optical resonators of the device. Furthermore, the spectrally separate data signals may have different polarization states.

The embodiments of the invention and their benefits will become more apparent to a person skilled in the art through the description and examples given herein below, and also through the appended claims.

### BRIEF DESCRIPTION OF THE FIGURES

In the following examples, the embodiments of the invention will be described in more detail with reference to the appended drawings, in which

FIG. 1 shows a block diagram of an optical communication system,

FIG. 2 shows, by way of example, a return-to-zero (RZ) modulated input signal and a corresponding clock signal,

FIG. 3a shows schematically the spectral decomposition of an optical data signal,

FIG. 3b shows schematically the spectral decomposition of a carrier-suppressed optical data signal,

FIG. 4 shows schematically an optical resonator based on a cavity defined by two reflectors,

FIG. 5 shows schematically a clock recovery device,

FIG. 6 shows schematically the matching of an optical resonator with the spectral peaks of an optical input signal,

FIG. 7 shows schematically the temporal behavior of a reference component, a sideband component, and a beat signal corresponding to the input signal of FIG. 2,

FIG. 8 shows a block diagram of an optical communication system adapted to transmit optical data signals at a plurality of optical channels,

FIG. 9 shows schematically the matching of an optical resonator with the spectral peaks associated with a plurality of spectrally separate optical data signals,

FIG. 10 shows schematically the matching of two optical resonators with the spectral peaks associated with a plurality of spectrally separate optical data signals,

FIG. 11 shows schematically a spectral demultiplexer coupled to a clock recovery device,

FIG. 12 shows schematically a clock recovery device where signals coupled out of an optical resonator are separated from signals coupled into said resonator by using optical circulators,

FIG. 13 shows schematically the propagation of the horizontally polarized component of the optical input signal in a clock recovery device, which comprises two optical resonators,

FIG. 14 shows schematically the propagation of the vertically polarized component of the optical input signal in the clock recovery device according to FIG. 13,

FIG. 15 shows schematically the propagation of the horizontally polarized component of the optical input signal in a clock recovery device, which comprises one optical resonator,

FIG. 16 shows schematically the propagation of the vertically polarized component of the optical input signal in a clock recovery device according to FIG. 15,

FIG. 17 shows schematically the propagation of the horizontally polarized component of the optical input signal in a clock recovery device, which comprises two optical micro ring resonators,

FIG. 18 shows schematically the propagation of the vertically polarized component of the optical input signal in a clock recovery device according to FIG. 17.

FIG. 19 shows schematically the propagation of the horizontally polarized component of the optical input signal in a clock recovery device, which comprises a Faraday rotator and two half waveplates,

FIG. 20 shows schematically the propagation of the vertically polarized component of the optical input signal in a clock recovery device according to FIG. 19,

FIG. 21 shows schematically the propagation of the horizontally polarized component of the optical input signal in a clock recovery device, which comprises a birefringent optical resonator,

FIG. 22 shows schematically the propagation of the vertically polarized component of the optical input signal in a clock recovery device according to FIG. 21,

FIG. 23 shows schematically a birefingent optical resonator,

FIG. 24 shows schematically the orientation of the birefringent resonator with respect to vertically polarized light,

FIG. 25 shows schematically an optical resonator based on a fiber optic grating,

FIG. 26 shows schematically an optical resonator based on two gratings,

FIG. 27 shows schematically an optical resonator based on a plurality of micro rings optically coupled in series,

FIG. 28 shows schematically the block diagram of a signal pre-processing unit coupled to a clock recovery device,

FIG. 29 shows schematically an output stabilization unit coupled to a clock recovery device,

FIG. 30 shows schematically spectral stabilization of the transmitting unit,

FIG. 31 shows schematically matching of an optical resonator and auxiliary light with the spectral peaks of optical data signals, and

FIG. 32 shows schematically combining of an output of a clock signal recovery device with auxiliary light.

### DETAILED DESCRIPTION

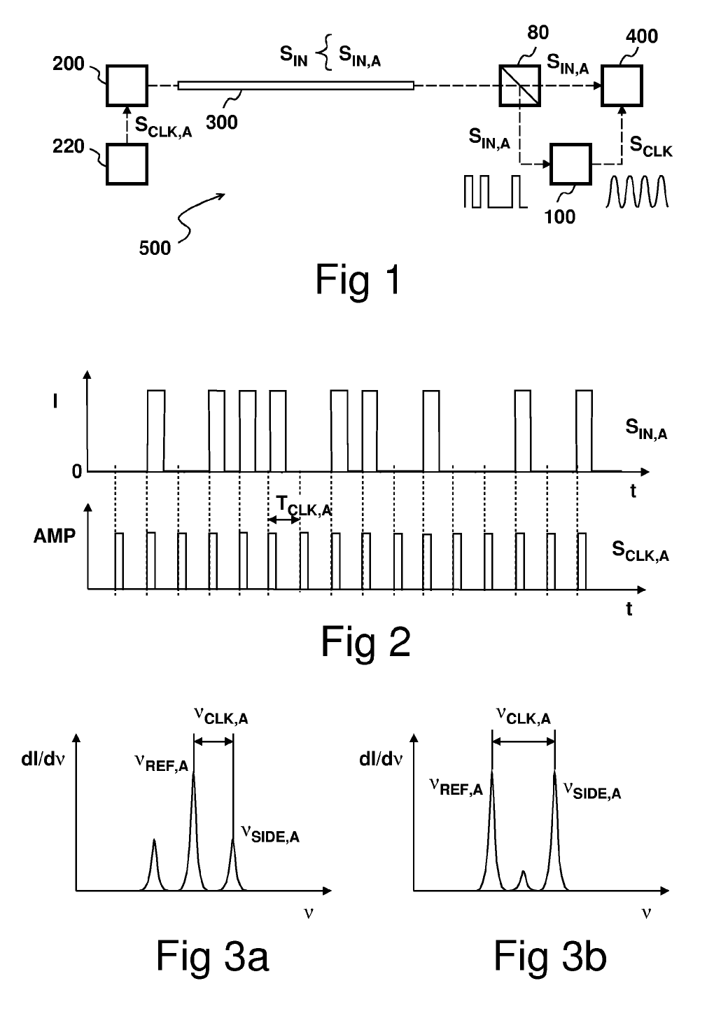

Referring to FIG. 1, an optical communication system 500 comprises an optical transmitting unit 200, an optical transmission path 300, and an optical receiving unit 400. An optical signal S_{IN} is sent by the transmitting unit 200. The optical signal S_{IN} is transmitted through the transmission path 300, which may be e.g. an optical fiber. The optical signal S_{IN} comprises at least one modulated data signal S_{IN,A}. The modulation of the signal S_{IN,A} is controlled by a clock signal S_{CLK,A} provided by a clock 220. The receiving unit 400 is synchronized with the data signal S_{IN,A} by using a clock signal S_{CLK,A} recovered by a clock recovery device 100. A splitter 80 may be used to distribute the signal S_{IN}.

Referring to FIG. 2, the data signal S_{IN,A} may consist of a sequence of pulses modulated e.g. according to the return-to-zero format (RZ). The timing of the pulses is controlled by the clock signal S_{CLK,A}, which is shown by the lower curve of FIG. 2. The time period between two consecutive clock pulses is T_{CLK,A}, and the clock frequency ν_{CLK,A} is equal to 1/T_{CLK,A}, respectively

The spectral decomposition of the modulated data signal S_{IN,A} may exhibit a spectral peak at a reference frequency ν_{REF,A} and a spectral peak at a sideband frequency ν_{SIDE,A} such that the spectral separation between the sideband frequency ν_{SIDE,A} and the reference frequency ν_{REF,A} is equal to the clock frequency ν_{CLK,A}. Referring to FIG. 3a, the reference frequency ν_{REF,A} may be the carrier frequency of the modulated signal S_{IN,A}.

Referring to FIG. 3b, the reference frequency ν_{REF,A} may also be a second sideband frequency of a carrier-suppressed modulated signal S_{IN,A}.

The spectral decomposition of the signal may exhibit several spectral peaks, from which a reference peak and a sideband peak may be selected such that their spectral separation is equal to the clock frequency ν_{CLK,A}.

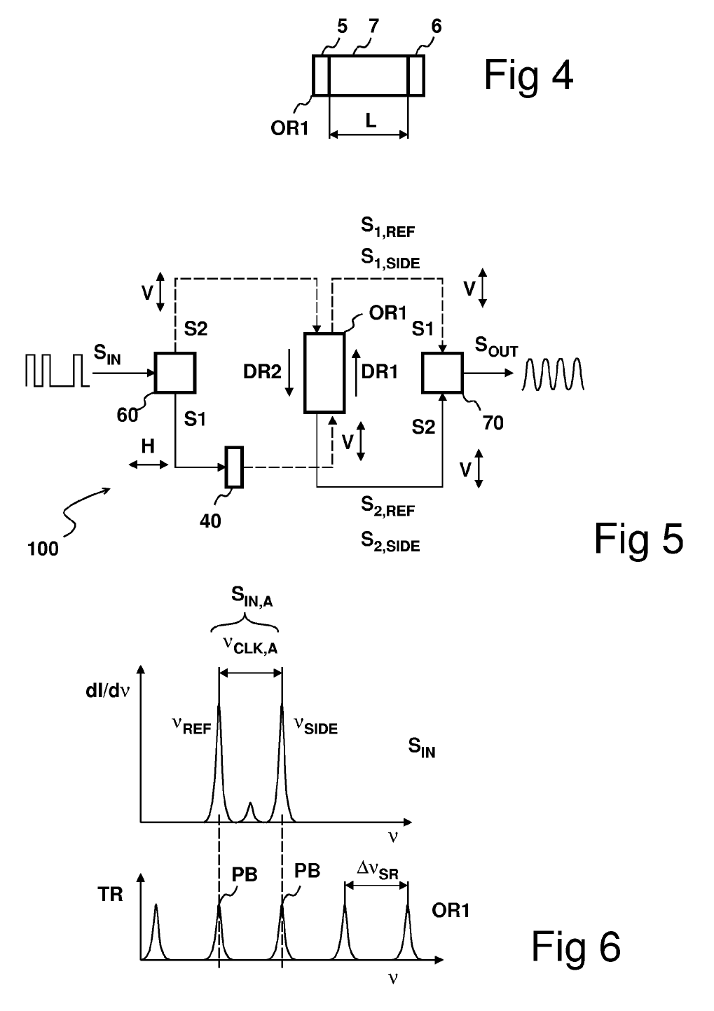

Referring to FIG. 4, an optical resonator OR1 may comprise a cavity 7 defined by two reflectors 5, 6. L denotes the length of the cavity 7. The resonator OR1 acts as a pass band filter having a plurality of pass bands PB (see FIG. 6), which coincide with the optical resonance frequencies of the resonator OR1. The reflectors 5, 6 may be e.g. planar or spherical surfaces. In case of planar reflective surfaces, adjacent resonance frequencies are separated by a separation range Δν_{SR} given by:

$$Δ {v}_{SR} = \frac{c}{2 nL} , \qquad ( 1 )$$

where c is the speed of light in vacuum and n is the index of refraction of the cavity medium.

The separation range Δν_{SR} may be substantially constant over a predetermined range of optical frequencies. In order to implement a constant separation range, the cavity 7 may be non-dispersive. Alternatively, the resonator OR1 may comprise further elements to compensate dispersion.

On the other hand, the resonator OR1 may also be dispersive to provide a wavelength-dependent separation range. Such a resonator may be used in applications where the pass bands should coincide with several optical channels which have non-equal separation in the frequency domain.

The optical resonator OR1 has a capability to store optical energy. This phenomenon is now discussed with reference to the resonator of FIG. 4. However, the discussion is relevant also regarding other types of optical resonators. Photons coupled into the resonator OR1 pass, in average, several times back and forth between the reflectors 5, 6 before escaping from the cavity 7. Thus, the resonator OR1 can sustain its state for some time regardless of perturbations of the optical input signal S_{IN}. The time constant τ of the resonator OR1 is given by the equation

$$τ = \frac{nL}{- c ln ( r )} , \qquad ( 2 )$$

where L is the length of the cavity 7, n is the refractive index of the cavity medium, c is the speed of light in vacuum, and r is the reflectance of the reflectors 5, 6. For example, by selecting the parameters r=0.99 and nL=1 mm, the time constant τ of the resonator is 332 picoseconds.

Advantageously, the time constant τ is selected to be greater than or equal to the average time period during which the input signal S_{IN} does not change its state.

In case of a return-to-zero (RZ) modulated signal, the time constant τ is advantageously selected to be greater than or equal to the average time period during which the data signal S_{IN,A} remains at zero.

In general, for example in the case of non-return-to-zero (NRZ) signals, the time constant τ is advantageously selected to be greater than or equal to the average time period during which the logical state of the data signal S_{IN,A} is not changed.

The cavity 7 may comprise passive or active, e.g. light-amplifying materials. However, the construction of the optical resonator OR1 has to be selected such that it is capable of processing several frequencies simultaneously. In certain types of construction, the use of active materials in the cavity 7 may limit the operation to only one frequency. FIG. 5 shows an embodiment of the clock recovery device 100. In order to eliminate the polarization dependence of the optical resonators and/or other components of the device 100, the input signal S_{IN} is divided into a horizontally H polarized first signal S1 and a vertically V polarized second signal S2 by a polarizing splitter 60. The polarization of the first signal S1 is rotated 90 degrees by a polarization rotator 40 such that the polarization of the first signal S1 is parallel to the vertical V polarization of the second signal S2. The parallel-polarized signals S1, S2 are passed through an optical resonator OR1 in opposite directions DR1, DR2. After the resonator OR1, the first S1 and the second S2 signals are combined by a combiner 70 to form an output signal S_{OUT} . The polarization rotator 40 may be e.g. a half waveplate.

It is noticed that only vertically polarized light is passed through the optical resonator OR1, regardless of the polarization of the input signal S_{IN}.

Referring to FIG. 6, one of the passbands PB of the optical resonator OR1 is matched with the reference frequency ν_{REF} of the input signal S_{IN}, and one of the passbands PB of the optical resonator OR1 is matched with the sideband frequency ν_{SIDE} of the input signal S_{IN}. The reference frequency ν_{REF} and the sideband frequency ν_{SIDE} are selected from the spectral decomposition of the input signal S_{IN} such that their spectral separation is equal to the clock frequency ν_{CLK}.

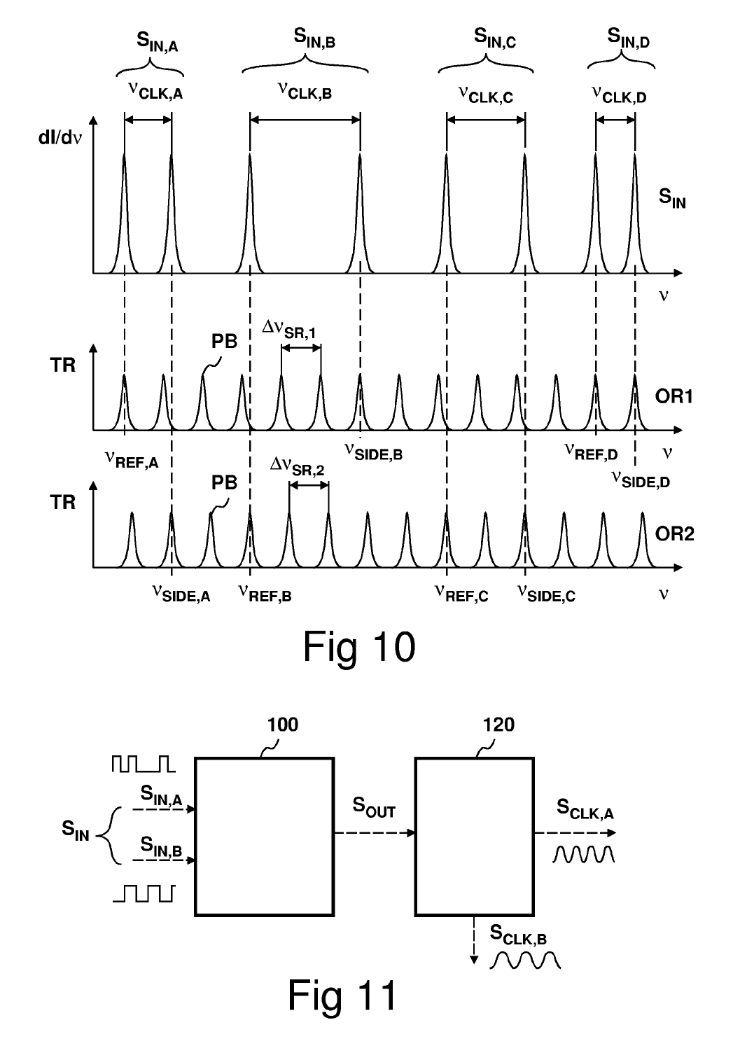

Alternatively, instead of the single optical resonator OR1 of FIG. 5, two optical resonators may be coupled optically in parallel. One of the passbands PB of the first optical resonator OR1 is matched with the reference frequency ν_{REF} of the input signal S_{IN}, and one of the passbands PB of the second optical resonator OR2 is matched with the sideband frequency ν_{SIDE} of the input signal S_{IN} (see FIG. 10). The use of two resonators OR1, OR2 provides more freedom to select the reference and sideband frequencies ν_{REF}, ν_{SIDE}, and the separation ranges Δν_{SR} of the resonators OR1, OR2.

Referring back to FIG. 5, the first signal S1 consists of at least two spectral components S_{1,REF}, S_{1,SIDE} after passing through the optical resonator OR1. The component S_{1,REF} is at the reference frequency ν_{REF}, and the component S_{1,SIDE} is at the reference frequency ν_{REF}, respectively. The second signal S2 consists of at least two spectral components S_{2,REF}, S_{2,SIDE} after passing through the optical resonator OR1. The component S_{2,REF} is at the reference frequency ν_{REF}, and the component S_{2,SIDE} is at the reference frequency ν_{REF}. The output signal S_{OUT} is the superposition of the components S_{1,REF}, S_{1,SIDE}, S_{2,REF}, S_{2,SIDE}.

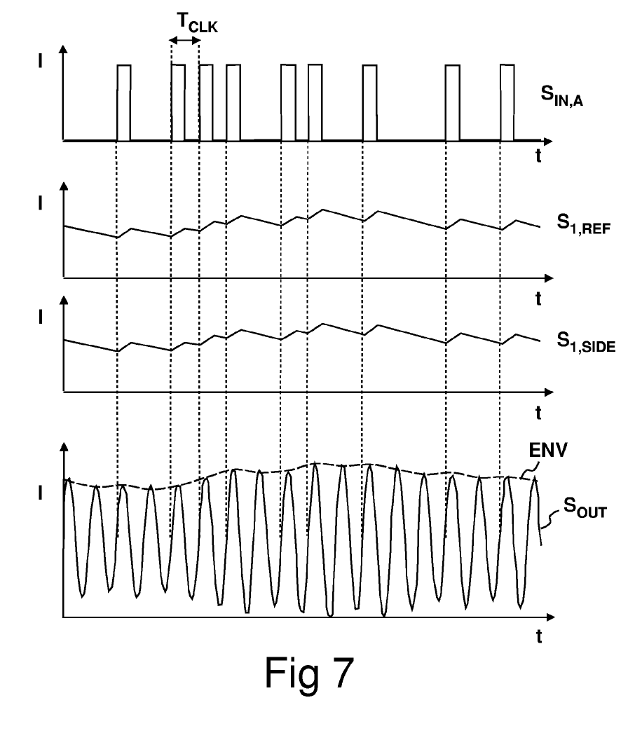

FIG. 7 shows the temporal behavior of the reference component S_{1,REF} and the sideband component S_{1,SIDE} corresponding to the horizontally H polarized part of the return-to-zero-modulated (RZ) data signal S_{IN,A} of FIG. 2. The uppermost curve shows the data signal S_{IN,A}. The second curve from the top shows the temporal behavior of the reference component S_{1,REF}. The third curve from the top shows the temporal behavior of the sideband component S_{1,SIDE}. The intensities of the reference component S_{1,REF} and the sideband component S_{1,SIDE} decrease when no optical energy is introduced to the optical resonator OR1. In other words, the optical resonator OR1 is discharged. The intensities of the reference component S_{1,REF} and the sideband component S_{1,SIDE} increase when optical energy is introduced into the optical resonator OR1. In other words, the optical resonator OR1 is charged.

Also the reference component S_{2,REF} (FIG. 5) and the sideband component S_{2,SIDE} corresponding to the vertically V polarized part of the data signal S_{IN,A} fluctuate in a similar way as the above-mentioned components S_{1,REF} and S_{1,SIDE}.

The lowermost curve of FIG. 7 shows the temporal behavior of the output signal S_{OUT}, which is the superposition of the components S_{1,REF}, S_{1,SIDE}, S_{2,REF}, S_{2,SIDE}. The output signal S_{OUT} exhibits beat at the clock frequency ν_{CLK} corresponding to the modulation of the input signal S_{IN}. The envelope ENV of the output signal S_{OUT} fluctuates according to the fluctuating components S_{1,REF}, S_{1,SIDE}, S_{2,REF}, S_{2,SIDE}. It is emphasized that although the envelope ENV fluctuates, the amplitude of the beat of the output signal approaches zero only when the data signal S_{IN} is at a zero level for a long time. Thus, the output signal S_{OUT} comprises the recovered continuous clock signal. The clock recovery device 100 may comprise means to stabilize the amplitude and/or waveform of the recovered clock signal.

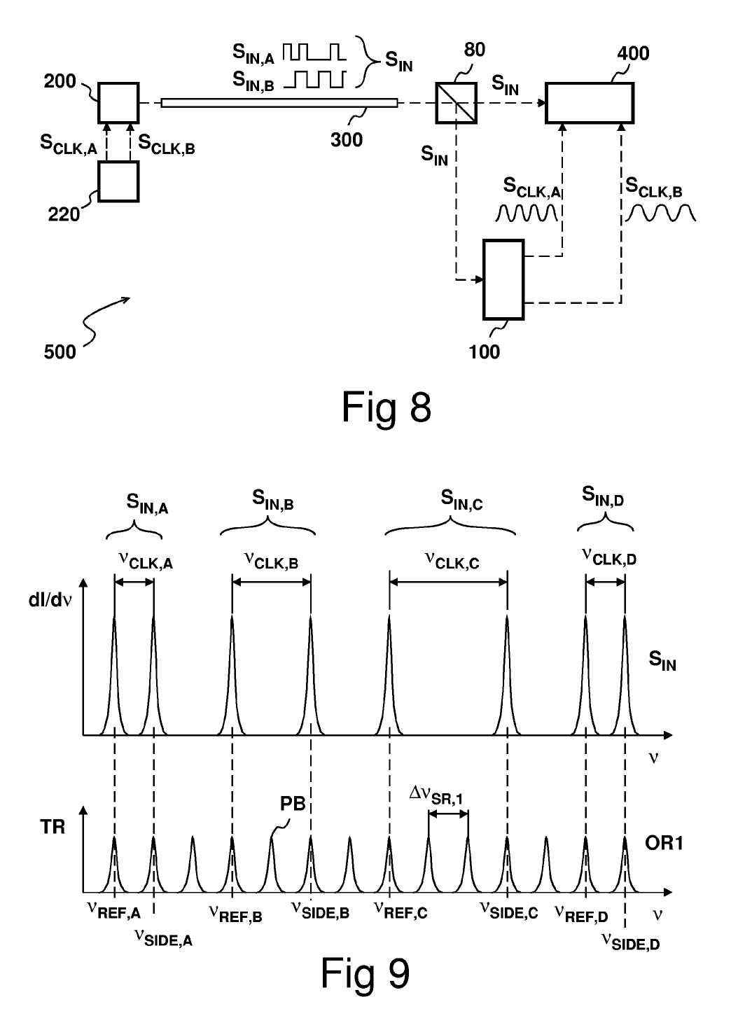

Referring to FIG. 8, the optical input signal S_{IN} may comprise several optical data signals S_{IN,A}, S_{IN,B}, which are sent through the same transmission path 300 but which are spectrally separate from each other, i.e. sent at different optical channels. The data signals S_{IN,A}, S_{IN,B} may have different clock frequencies ν_{CLK,A}, ν_{CLK,B}. The clock frequencies of the different data signals may also be the equal but in different phases. The receiving unit 400 is synchronized with the incoming data signals S_{IN,A}, S_{IN,B} by recovering the associated clock signals S_{CLK,A} and S_{CLK,B}. Several clock signals may be recovered simultaneously by the clock recovery device 100.

Referring to FIG. 9, a plurality of spectral peaks may be simultaneously matched with the pass bands PB of an optical resonator OR1. When one optical resonator OR1 is used, the spectral separation between the spectral peaks is selected to be equal to an integer multiple of the separation range Δν_{SR,1} of the optical resonator OR1, e.g. one, two or three times the separation range Δν_{SR,1}. The optical resonator OR1 stores optical energy at the matched frequencies. Thus, the clock recovery device 100 may simultaneously provide a plurality of continuous beat signals which correspond to the clock signals of the several data channels. The first data signal S_{IN,A} consists of spectral peaks at ν_{REF,A} and ν_{SIDE,A}, and it has a clock frequency ν_{CLK,A}. The second data signal S_{IN,B} has spectral peaks at ν_{REF,B} and ν_{SIDE,B}, and a clock frequency ν_{CLK,B}. The third data signal S_{IN,C} has spectral peaks at ν_{REF,C} and ν_{SIDE,C}, and a clock frequency ν_{CLK,C}. The fourth data signal S_{IN,D} has spectral peaks at ν_{REF,D} and ν_{SIDE,D}, and a clock frequency ν_{CLK,D}. Although the clock frequencies ν_{CLK,A} and ν_{CLK,D} may be equal in this example, they may be in different phases, i.e. the clock signals associated with the first S_{IN,A} and the fourth data S_{IN,D} signal may be different.

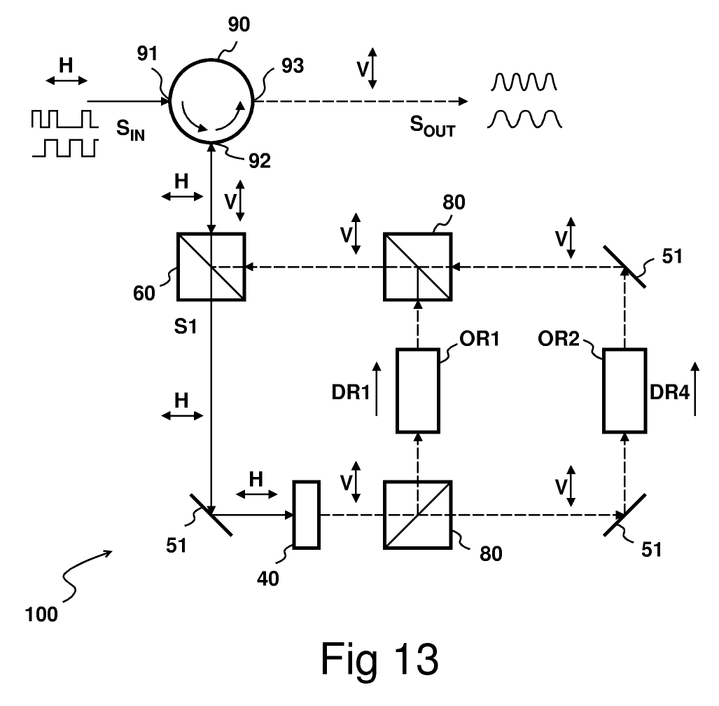

The clock recovery device 100 may also comprise two, three or more optical resonators OR1, OR2 coupled in parallel (see FIGS. 13, 17, 19, 21). The use of two or more optical resonators OR1, OR2 allows substantial freedom to select the spectral positions of the optical data signals, and the clock frequencies of those data signals.

Referring to FIG. 10, the spectral peaks of the optical data signals S_{IN,A}, S_{IN,B}, S_{IN,C}, S_{IN,D} are matched with one of the pass bands PB of the optical resonators OR1, OR2. For example, the peaks ν_{REF,A}, ν_{SIDE,B}, ν_{REF,D} and ν_{SIDE,D} may be matched with the first optical resonator OR1, and the peaks ν_{SIDE,A}, ν_{REF,B}, ν_{REF,C} and ν_{SIDE,C} may be matched with the second optical resonator OR2.

The spectral peaks are selected from the spectral decomposition of the input signal S_{IN} such that their spectral separation is equal to the clock frequencies ν_{CLK,A}, ν_{CLK,B} associated with the data signals S_{IN,A}, S_{IN,B}. The spectral decomposition may be obtained e.g. by Fourier analysis of the input signal S_{IN}.

The first optical resonator OR1 has a separation range Δν_{SR,1} between adjacent passbands PB. The second optical resonator OR2 has a separation range Δν_{SR,2} between adjacent passbands PB. The first optical resonator OR1 and the second optical resonator OR2 may have equal or different separation ranges Δν_{SR,1} and Δν_{SR,2}.

In general, one pass band PB of the optical resonator/resonators is set to match with reference frequency and one pass band PB of the optical resonator/resonators is set to match with the sideband frequency for each optical data signal from which the clock frequency is to be recovered.

The number of the recovered clock frequencies may be significantly higher than the number of the optical resonators OR1, OR2. For example, four different clock frequencies may be recovered using one optical resonator OR1 only.

The polarization states of the data signals S_{IN,A}, S_{IN,B} may be horizontally polarized, vertically polarized, linearly polarized in a direction which is different from the vertical and horizontal directions, circularly clockwise-polarized, circularly anti-clockwise-polarized, elliptically clockwise-polarized or elliptically anti-clockwise-polarized. When an ordinary polarizing splitter 60 is used to divide the input signal S_{IN} into the first signal S1 and the second signal S2, then the first signal S2 and the second signal S2 are linearly polarized.

When the first signal S1 and the second signal S2 are linearly polarized, the clock recovery method comprises:
dividing the input signal S_{IN} into a first linearly polarized signal S1 and a second linearly polarized signal S2 such that the initial polarization of the first signal is perpendicular to the initial polarization of the second signal S2,
rotating the polarization of one or both of the signals S1, S2 such that the polarization of the first signal S1 becomes parallel to the polarization of the second signal S2
coupling the first signal S1 to pass from a first end of an optical resonator OR1 to a second end of an optical resonator OR1, and
coupling the second signal S2 to pass from the second end of said optical resonator OR1 to the first end of said optical resonator OR1.

However, the first signal S1 and the second signal S2 may also be arranged to be circularly clockwise-polarized, circularly anti-clockwise-polarized, elliptically clockwise-polarized or elliptically anti-clockwise-polarized when they pass through the optical resonator OR1.

In general, the polarization-independence of the clock recovery device 100 is implemented by arranging the first signal S1 and the second signal S2 to have the same polarization state when they pass through the optical resonator OR1 or resonators. For example, both signals S1 and S2 may be elliptically clockwise-polarized when they pass through the optical resonator OR1 in opposite directions DR1, DR2 such that the major axes associated with the elliptical polarization of the signals S1, S2 coincide.

In general, the clock recovery method comprises:
dividing the input signal S_{IN} into a first signal S1 and a second signal S2 such that the initial polarization state of the first signal is different from the initial polarization state of the second signal S2,
altering the polarization state of one or both of the signals S1, S2 such that the polarization state of the first signal S1 becomes the same as the polarization state of the second signal S2,
coupling the first signal S1 to pass from a first end of an optical resonator OR1 to a second end of an optical resonator OR1, and
coupling the second signal S2 to pass from the second end of said optical resonator OR1 to the first end of said optical resonator OR1.

Referring to FIG. 11, the optical clock signals S_{CLK,A}, S_{CLK,B} may be spatially separated from the output signal S_{OUT} by a spectral demultiplexer 120 in order to provide spatially separate optical clock signals S_{CLK,A}, S_{CLK,B}, if required. The spectral demultiplexer may be based e.g. on a diffraction grating, on an arrayed waveguide or on the use of interference filters. The first clock signal S_{CLK,A} exhibits beat at the first clock frequency ν_{CLK,A} of the first data signal S_{IN,A}. The second clock signal S_{CLK,B} exhibits beat at the second clock frequency ν_{CLK,B} of the second data signal S_{IN,B}.

Spectral positions of optical channels in fiber optic networks have been standardized e.g. by the International Telecommunication Union. The separation between optical channels, i.e. the separation ΔνAB between the reference frequencies ν_{REF,A}, ν_{REF,B} may be e.g. 100 GHz in the frequency domain.

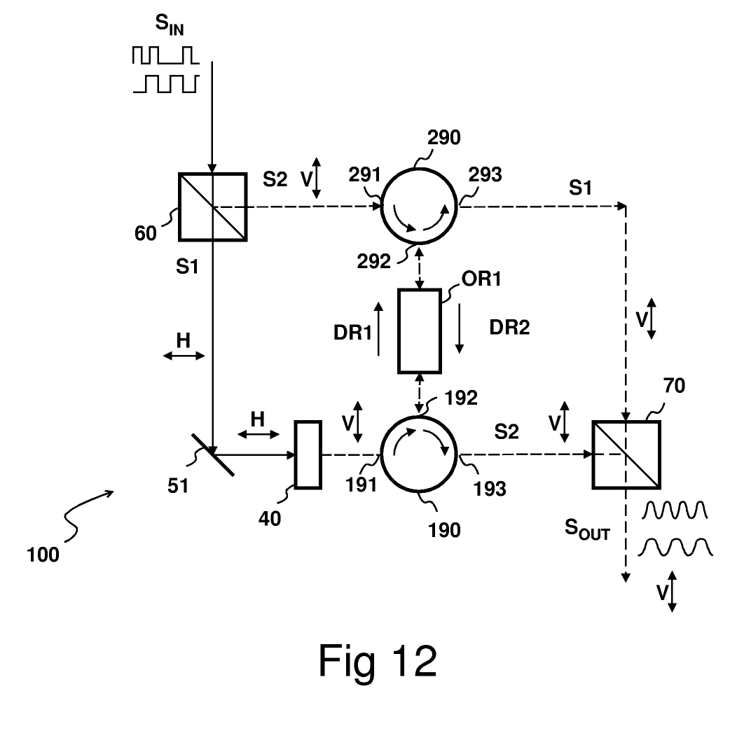

An embodiment of the clock signal recovery device 100 having one optical resonator OR1 is shown in FIG. 12. An input signal S_{IN} having arbitrary polarization state is divided by a polarizing splitter 60 into a first signal S1 having horizontal H polarization and into a second signal S2 having vertical V polarization. The polarization of the first signal S1 is rotated 90 degrees by a polarization rotator 40 such that its polarization becomes vertical V.

A first optical circulator 190 has three ports 191, 192, 193. An optical signal is routed from the first port 191 to the second port 192. An optical signal is routed from the second port 192 to the third port 193. A second optical circulator 290 has three ports 291, 292, 293. An optical signal is routed from the first port 291 to the second port 292. An optical signal is routed from the second port 292 to the third port 293.

The passbands of the optical resonator OR1 are matched at least with a first ν_{REF,A}, a second ν_{SIDE,A}, a third ν_{REF,B}, and a fourth ν_{SIDE,B} spectral peak the input signal S_{IN} such that the spectral separation between the first peak and the second peak is equal to a first clock frequency ν_{CLK,A} associated with a first data signal S_{IN,A}, and such that the spectral separation between the third peak and the fourth peak is equal to a second clock frequency ν_{CLK,B} associated with a second data signal S_{IN,B}.

The vertically V polarized first signal S1 is routed from port 191 to port 192 and it passes through the optical resonator OR1 in a first direction DR1. The vertically V polarized second signal S2 is routed from port 291 to port 292 and it passes through the optical resonator OR1 in a second direction DR2. After passing through the optical resonator OR1, the first signal S1 is routed from port 292 to 293. After passing through the optical resonator OR1, the second signal S2 is routed from port 192 to port 193. Subsequently, the first signal S1 and the second signal S2 are combined by a combiner 70 in order to form an output signal S_{OUT} The output signal S_{OUT} comprises at least a first recovered clock signal S_{CLK,A} and a second recovered clock signal S_{CLK,B}.

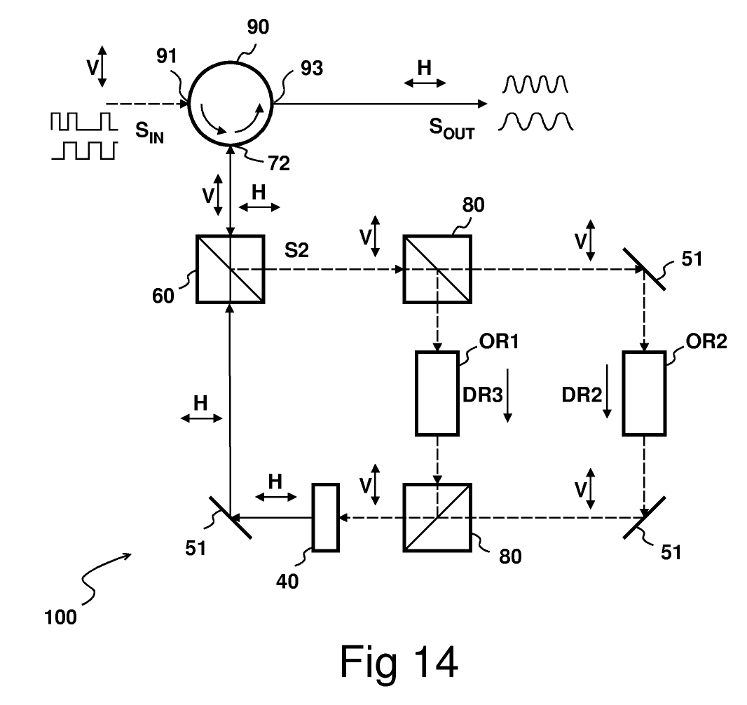

An embodiment comprising two optical resonators OR1, OR2 is shown in FIGS. 13 and 14. The input signal S_{IN} may have arbitrary, random or predetermined polarization. The input signal S_{IN} may be considered to consist of a horizontally H and vertically V polarized part. The processes described with reference to FIGS. 13 and FIG. 14 take place simultaneously, and the output signal S_{OUT} is the sum of the contributions related to the horizontally H and vertically V polarized part of the input signal S_{IN}.

Referring to FIG. 13, the input signal S_{IN} is transmitted to a polarizing splitter 60 by an optical circulator 90. The port 91 of the circulator 90 transmits an optical signal from port 91 to port 92, and the port 92 transmits an optical signal from port 92 to port 93.

The input signal S_{IN} is divided into a horizontally H polarized first signal S1 and a vertically V polarized second signal S2 by the polarizing splitter 60. Only the propagation of the first signal S1 is shown in FIG. 13. The propagation of the second signal S2 will be described later with reference to FIG. 14.

The polarization of the first signal S1 is rotated 90 degrees by a polarization rotator 40, i.e. from horizontal H polarization to vertical V polarization. Subsequently, the first signal S1 is distributed to two optical resonators OR1, OR2 by using e.g. a non-polarizing splitter 80.

The polarization rotator 40 may be e.g. a waveplate, a twisted single-mode fiber, a twisted polarization-maintaining fiber and/or waveguide, a birefringent optical element with suitably oriented optical axis and optical length, a Faraday rotator, a solid plate comprising chiral molecules, a photonic structure comprising chiral molecules, or a liquid cell comprising chiral molecules. Any known medium or device may be used which changes the polarization of an incoming signal.

Mirrors 51 may be used to guide and direct light. An arrangement comprising reflecting surfaces, e.g. four mirrors, may also be used for rotating the polarization.

The first optical resonator OR1 is matched with the reference frequency ν_{REF} of the input signal S_{IN}. The second optical resonator OR1 is matched with the sideband frequency ν_{SIDE} of the input signal S_{IN} such that the difference ν_{SIDE}-ν_{REF} is equal to the clock frequency ν_{CLK} of the input signal S_{IN}. The first signal S1 is transmitted through the first optical resonator OR1 in the direction DR1 and through the second optical resonator OR2 in the direction DR4.

The outputs of the resonators OR1, OR2 are combined by a non-polarizing splitter 80, which now acts as a combiner. The combined output is further coupled to the second port 92 of the optical circulator 90 by the polarizing splitter 60.

The second port 92 of the optical circulator 90 is adapted to transmit a signal to the output port 93. In this embodiment, the input signal S_{IN} coupled to the polarizing splitter 60 and the output signal S_{OUT} provided by the polarizing splitter 60 propagate along the same path, and the purpose of the optical circulator 90 is to separate the output signal S_{OUT} from the input signal S_{IN}. The output signal S_{OUT} is provided by the output port 93.

Now, referring to FIG. 14, the vertically V polarized second signal S2 is distributed to the optical resonators OR1, OR2 by using the non-polarizing splitter 80. The second signal S2 is transmitted through the first optical resonator OR1 in the direction DR3 and through the second optical resonator OR2 in the direction DR2. The outputs of the resonators OR1, OR2 are combined by the non-polarizing splitter 80. The polarization of the second signal S2 is rotated 90 degrees by a polarization rotator 40, i.e. from vertical V polarization to horizontal H polarization. The rotated second signal S2 is further coupled to the optical circulator 90 by the polarizing splitter 60.

It is noticed that only vertically V polarized light is transmitted through the optical resonators OR1, OR2, irrespective of the original polarization of the input signal S_{IN}. Thus, a possible polarization dependence of the optical resonators OR1, OR2 does not require re-adjustment of the resonators OR1, OR2 when the polarization of the input signal S_{IN} varies.

Instead of being a linear combination of horizontally H polarized and vertically V polarized components, the input signal S_{IN} may also consist of horizontally H polarized light only or of vertically V polarized light only. The data signals S_{IN,A}, S_{IN,B} of the input signal S_{IN} may have different polarization state.

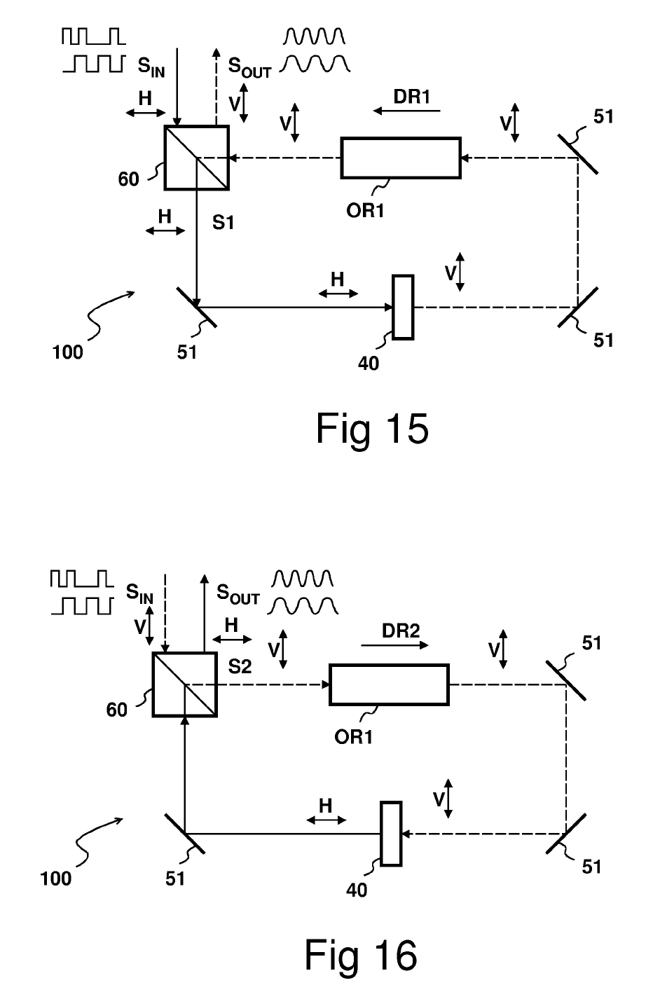

With reference to FIGS. 15 and 16, the arbitrarily polarized input signal S_{IN} is divided into the horizontally H polarized first signal S1 and a vertically V polarized second signal S2 by the polarizing splitter 60. The processing of the horizontally H polarized first signal S1 is shown in FIG. 15, and the processing of the vertically polarized V polarized second signal S2 will be shown in FIG. 16

Referring to FIG. 15, the initially horizontally H polarized first signal S1 is rotated 90 degrees by the polarization rotator 40. The vertically V polarized signal is coupled to an optical resonator OR1, and after passing through the resonator OR1 the vertically V polarized signal is reflected by the polarizing beam splitter 60 to contribute to the output signal S_{OUT}.

The polarizing beam splitter 60 may also be arranged such that the vertically V polarized signal is transmitted straight through the polarizing beam splitter 60 and the horizontally polarized signal is reflected by the polarizing beam splitter 60. The polarizing beam splitter 60 may also be e.g. a fiber optic beam splitter/combiner, in which both vertically V and horizontally H polarized signal are transmitted through the splitter.

Referring to FIG. 16, the initially vertically V polarized second signal S2 is passed through the optical resonator OR1, and after passing through the resonator OR1 it is rotated 90 degrees by the polarization rotator 40. The horizontally H polarized second signal S2 is transmitted straight through the polarizing beam splitter 60 to contribute to the output signal S_{OUT}.

The optical resonator OR1 is matched with the reference frequency νν_{REF} and the sideband frequency ν_{SIDE} of the input signal S_{IN} such that the spectral separation between said frequencies is equal to the clock frequency ν_{CLK}.

The separation range Δν_{SR} of the optical resonator OR1 may be selected such that it is equal to the clock frequency ν_{CLK}. Alternatively, the separation range Δν_{SR} of the optical resonator OR1 may be selected such that the clock frequency ν_{CLK} is substantially equal to the separation range Δν_{SR} multiplied by an integer greater than or equal to two.

The first signal S1 is transmitted through the optical resonator OR1 in the direction DR1 and the second signal is transmitted through the optical resonator OR1 in the opposite direction DR2. Only vertically V polarized light is transmitted through the resonator OR1.

The polarizing splitter 60 acts also as a combiner which combines the signals S1, S2 after they have passed through the resonator OR1, in order to form the output signal S_{OUT}.

The output signal S_{OUT} may be separated from the input signal S_{IN} by e.g. using a non-polarizing splitter or an optical circulator (FIG. 13).

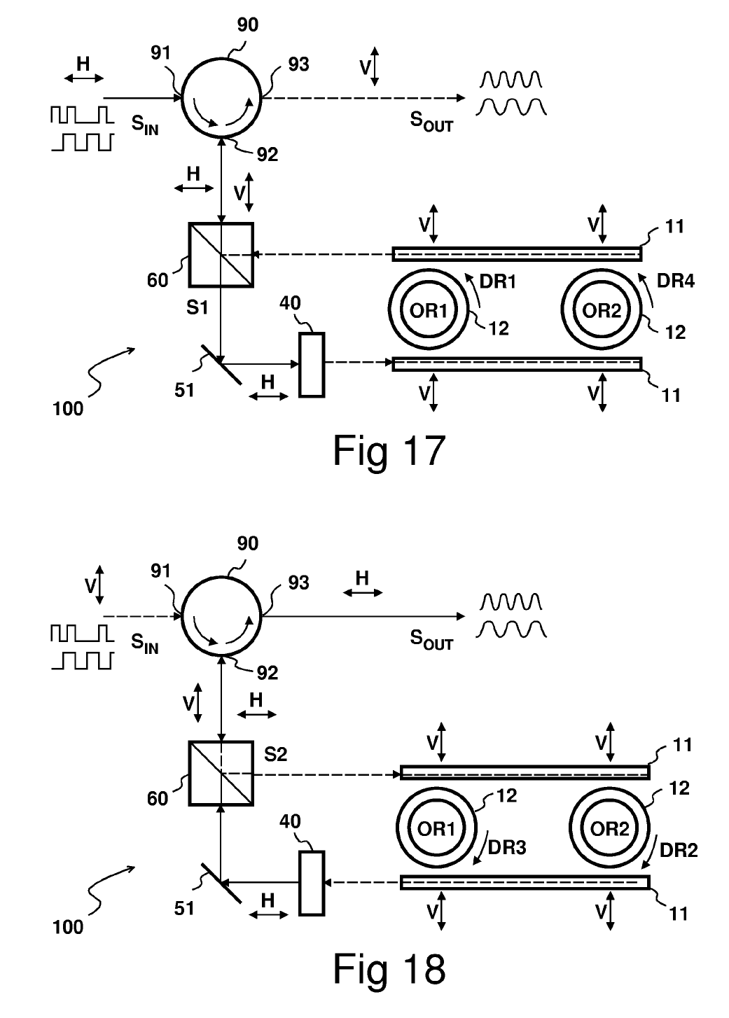

Referring to FIGS. 17 and 18, the optical resonators OR1, OR2 may be micro ring resonators 12. Waveguides 11 may be arranged to couple light in and out from the micro ring resonators 12 by evanescent coupling. In case of the micro ring resonators 12, the non-polarizing splitters 80 of FIG. 13 may be omitted. A single micro ring resonator 12 may be used instead of two resonators OR1, OR2. Also three or more micro ring resonators 12 may be used.

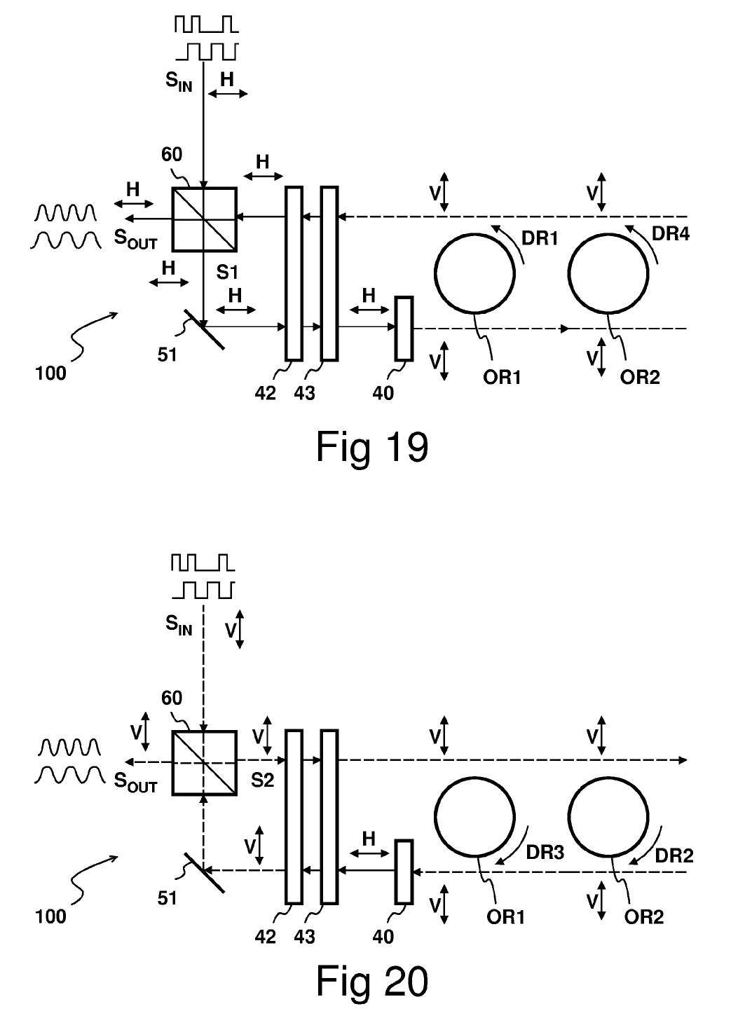

Referring to FIGS. 19 and 20, the optical circulator of FIGS. 17 and 18 may be integrated into the clock recovery device 100 using an additional half-waveplate 42 and a Faraday rotator 43.

The arbitrarily polarized input signal S_{IN} is divided into the first and second signals S1, S2 by the polarizing splitter 60. The propagation of the horizontally H polarized first signal S1 is shown in FIG. 19. The propagation of the vertically V polarized second signal S2 will be shown in FIG. 20.

Referring to FIG. 19, the horizontally H polarized signal S1 is rotated by 45 degrees by the half waveplate 42. The angle between the optical axis of the waveplate 42 and the polarization of the signal S1 is 22.5 degrees. The Faraday rotator 43 rotates the polarization counterclockwise by 45 degrees such that the polarization of the first signal S1 remains horizontal H. Next, the polarization is rotated 90 degrees by the polarization rotator 40. The vertically V polarized first signal S1 is transmitted through the optical resonators OR1, OR2. The polarization rotator 40 may also be a half waveplate. After passing through the optical resonators OR1, OR2, the polarization of the first signal S1 is rotated 45 degrees by the Faraday rotator 43 and another 45 degrees by the half waveplate 42. The horizontally H polarized first signal S1 is transmitted straight through the polarizing splitter 60 to contribute to the output signal S_{OUT}.

Referring to FIG. 20, the vertically V polarized second signal S2 is rotated 45 degrees by the half waveplate 42. The Faraday rotator 43 rotates the polarization counterclockwise by 45 degrees such that the polarization of the second signal S2 remains vertical V. The vertically V polarized second signal S2 is transmitted through the optical resonators OR1, OR2. After passing through the optical resonators OR1, OR2, the polarization of the second signal S2 is rotated 90 degrees by the polarization rotator 40. Further, the polarization of the second signal S2 is rotated 45 degrees by the Faraday rotator 43 and another 45 degrees by the half waveplate 42. The vertically V polarized second signal S2 is reflected by the polarizing splitter 60 to contribute to the output signal S_{OUT}.

Only vertically V polarized light only is coupled to the optical resonators OR1, OR2. The output signal S_{OUT} propagates in a direction perpendicular to the direction of the input signal S_{IN}. In case of FIGS. 19 and 20 the output signal S_{OUT} has the same polarization state as the input signal S_{IN}.

The optical resonators OR1, OR2 may also be other types of resonators than the micro ring resonators. Only a single resonator OR1 may be used.

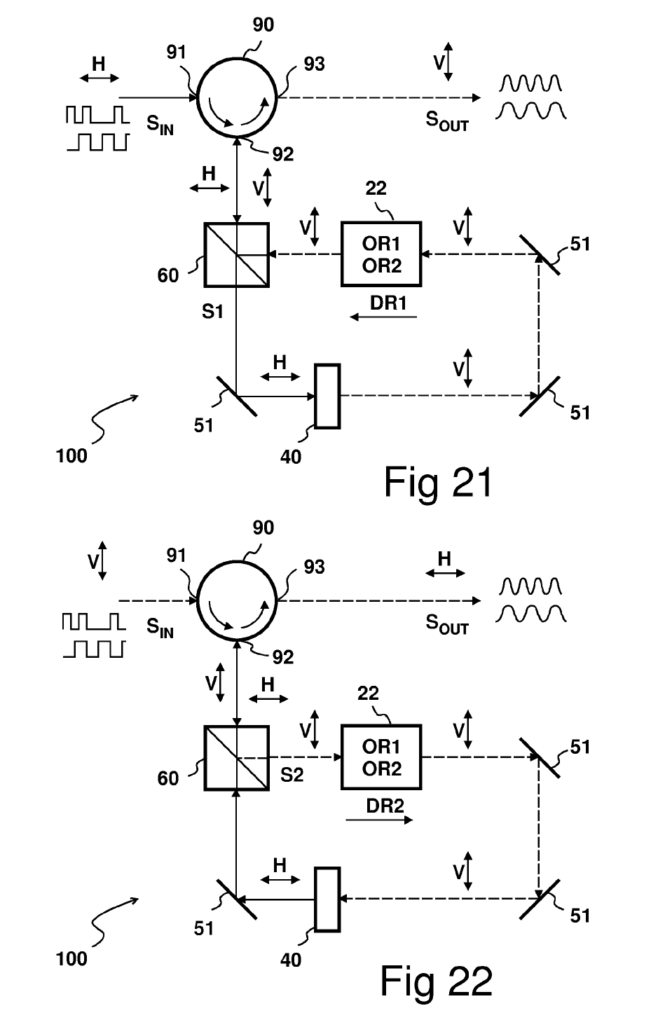

Referring to FIGS. 21 and 22, the clock recovery device 100 may be implemented using a single birefringent optical resonator 22, instead of two physically separate resonators OR1, OR2. The birefringent optical resonator 22 may be simultaneously matched with the reference ν_{REF} and sideband peak ν_{SIDE} of the input signal S_{IN}.

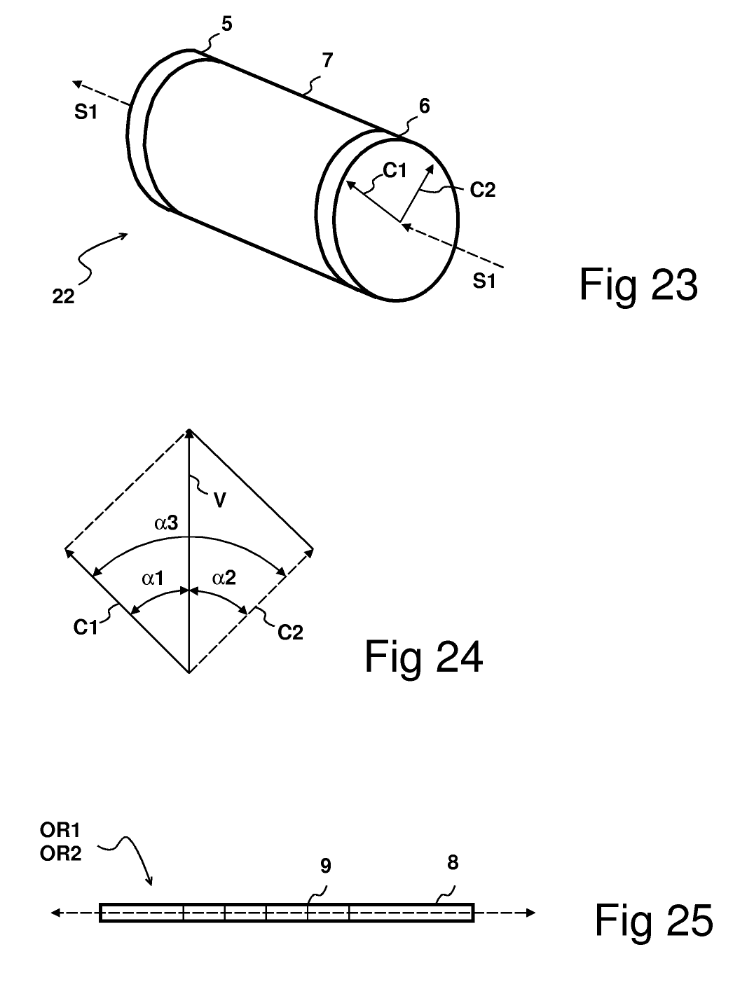

Referring to FIG. 23, the birefringent optical resonator 22 comprises a cavity 7 defined by two reflectors 5, 6. The cavity 7 comprises birefingent medium such that the index of refraction for light polarized in the direction of the vector C1 is different from the index of refraction for light polarized in the direction of the vector C2, the vector C2 being perpendicular to the vector C1.

Referring to FIG. 24, the angle α1 between the vector C1 and the vertical polarization direction V may be equal to e.g. 45 degrees, and the angle α2 between the vector C2 and vertical polarization direction V is equal to 90°-α1. A vertically V polarized optical signal propagating through the birefringent resonator 22 may be considered as a sum components polarized in the directions of the vectors C1 and C2. The optical length nL of the cavity 7 is different for these components. Thus, the birefringent resonator 22 is equivalent to two optical resonators OR1, OR2 coupled in parallel. A first separation range Δν_{SR} corresponding to the direction C1 may be adjusted with respect to a second separation range Δν_{SR} corresponding to the direction C2, by turning the birefringent resonator 22 and/or the birefringent medium.

Referring to FIG. 25, the optical resonators OR1, OR2 may be implemented using a fiber optic grating. The fiber optic grating comprises a portion of optical waveguide 8 comprising periodic features 9.

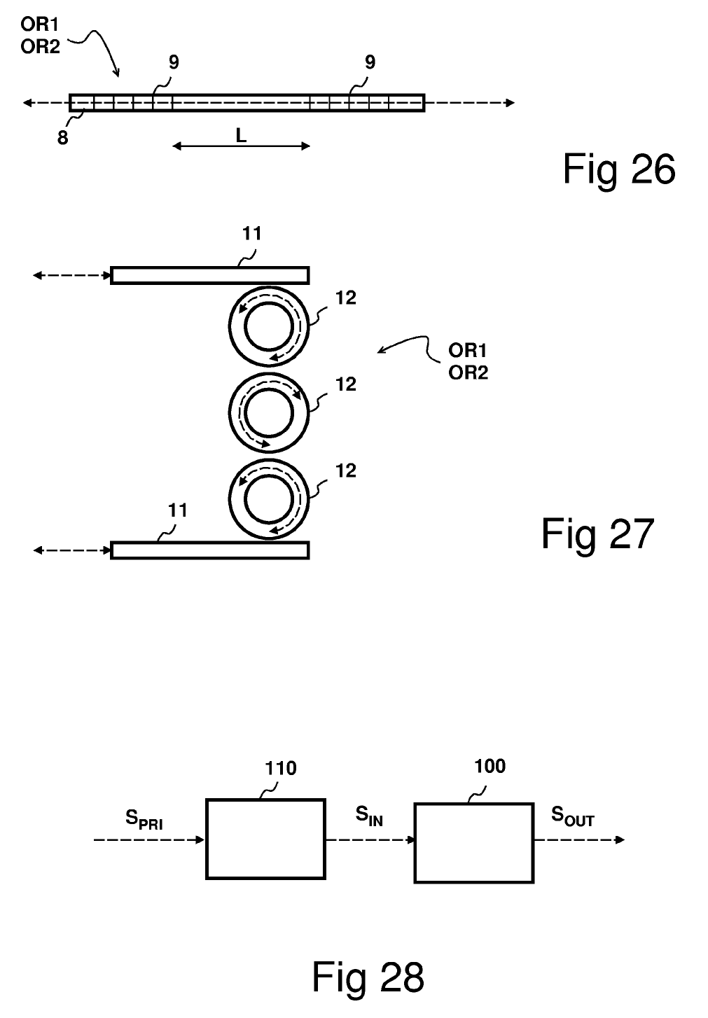

Referring to FIG. 26, the optical resonators OR1, OR2 may be implemented using structure which comprises two gratings, said gratings defining a cavity between them. The gratings may be Bragg gratings.

Referring to FIG. 27, the optical resonators OR1, OR2 may be implemented using a plurality of resonators optically coupled in series, e.g. micro ring resonators.

The coupling of the resonators in series may be used e.g. in order to modify the spectral profile of the passbands PB. Especially, the resonators may be coupled in series in order to implement a region of a substantially constant phase shift in the vicinity of a spectral peak, i.e. to implement a phase shift plateau. Thus, a slight mismatch between the spectral peak and the passband of the resonator will not affect the phase of the recovered clock signal.

The optical resonators OR1, OR2 may also be implemented using a resonator formed based on a fiber loop or a portion of a fiber defined between two reflectors (not shown). The optical resonator 100 may also be based on a grating based device, a monochromator, an arrayed waveguide grating, a periodic microstructure, a stack of thin films, or a combination thereof.

The optical resonators OR1, OR2 may be used in the transmissive mode or in the reflective mode.

Referring to FIG. 28, a optical primary signal S_{PRI} may be modulated in such a way that it does not originally comprise spectral components corresponding to the clock frequency ν_{CLK}. The optical signal may be modulated e.g. according to the non-return-to-zero (NRZ) format. A signal pre-processing unit 110 may be coupled to the clock recovery device 100 in order to generate one or more sideband peaks corresponding to the clock frequency ν_{CLK} of the primary signal S_{PRI}. The pre-processing unit 110 may be implemented by non-linear devices such as disclosed e.g. in U.S. Pat. No. 5,339,185.

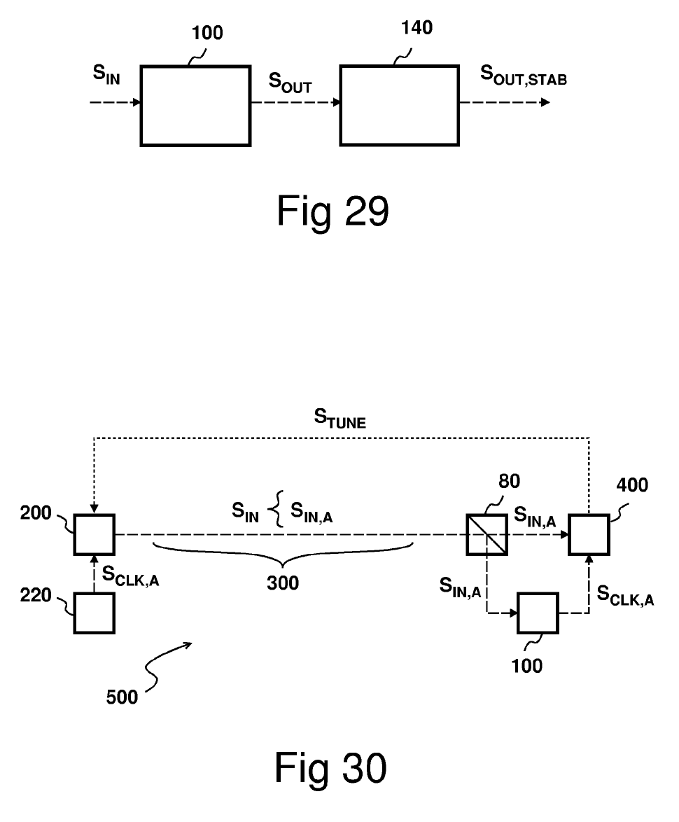

Referring to FIG. 29, an amplitude stabilization unit 140 may be coupled to the clock recovery device 100 in order to provide a signal S, _{OUT,STAB} which is stabilized with respect to the amplitude of the beat of the output signal S_{OUT} and/or to stabilize the waveform of the beat. The stabilization unit 140 may be based on an optical resonator exhibiting optical bistability. The stabilization unit 140 may be based on an optically saturable element. Yet, the stabilization unit 140 may be based on the use of one or more semiconductor optical amplifiers.

The optical resonator OR1 or the resonators OR1, OR2 of the clock recovery device 100 have to be matched with the spectral peaks of the input signal S_{IN}. The matching of the resonators OR1, OR2 may be achieved by tuning the resonators OR1, OR2. The tuning may be based e.g. on maximizing the amplitude of the beat, or on keeping the amplitude of the beat at a predetermined level, which is lower than the maximum amplitude.

Referring to FIG. 30, the spectral matching of the resonators OR1, OR2 may also be achieved by spectrally tuning the transmitting unit 200. A control signal S_{TUNE} is sent from the receiving end to the transmitting unit 200. The control signal S_{TUNE} may be based e.g. on the magnitude of the beat signal. The transmitting unit 200 may be tuned such that the beat amplitude is maximized or kept at a predetermined level. The control signal S_{TUNE} may sent optically through the same optical transmission path 300 which is used for transmitting the optical input signal S_{IN}. The control signal S_{TUNE} may be sent optically through another transmission path. The control information may also be sent electrically or by radio communication.

Thus, the optical system may further comprise:
means to monitor the spectral position of a spectral peak of the input signal S_{IN} with respect to at least one pass band of an optical resonator OR1,
means to send a control signal S_{TUNE} to the optical transmitting unit 200, which control signal S_{TUNE} is depends on said spectral position, and
means to spectrally tune the transmitting unit 200 based on said control signal S_{TUNE} in order to stabilize said spectral position.

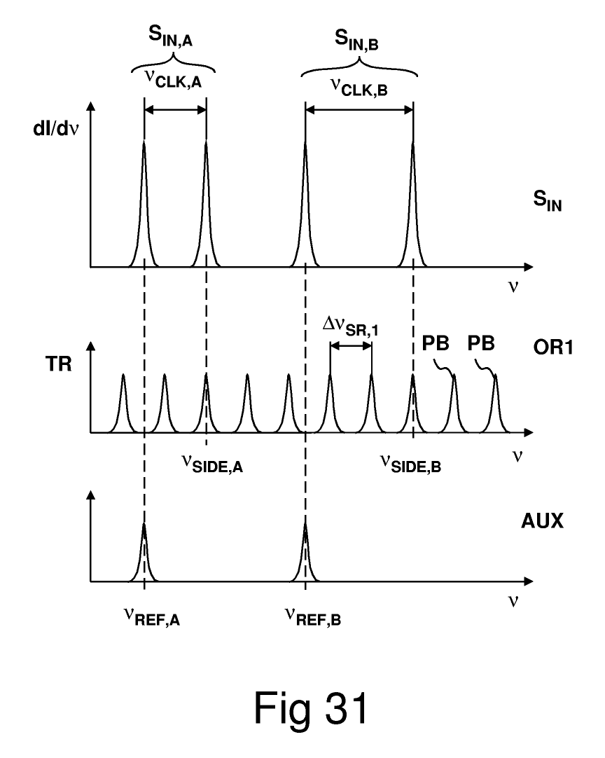

Referring to FIG. 31, auxiliary light AUX may be combined with the outputs of the optical resonator OR1 in order to further stabilize the beat amplitude of the recovered clock frequencies.

A first and a third spectral peak of the input signal S_{IN} is matched with passbands PB of the first ring resonator OR1. Spectral peaks of the auxiliary light AUX are matched with a second and a fourth spectral peak of the input signal S_{IN}. The auxiliary light AUX has spectral peaks at frequencies ν_{REF,A}, ν_{REF,B} that correspond to the reference peaks of the data signals S_{IN,A}, S_{IN,B}. The spectral separation between the peaks of the auxiliary light and the spectral peaks of the data signals is selected to be equal to the clock frequency ν_{CLK,A}, ν_{CLK,B} of each data signal S_{IN,A}, S_{IN,B}.

The auxiliary light AUX is combined with the output of the optical resonator OR1 in order to recover the clock signals S_{CLK,A}, S_{CLK,B} associated with the data signals S_{IN,A}, S_{IN,B}. The clock signals S_{CLK,A}, S_{CLK,B} exhibit beat at the clock frequencies ν_{CLK,A}, ν_{CLK,B}.

When compared with the signal S_{REF,A} shown in FIG. 7, the intensity of the auxiliary light AUX does not fluctuate. Thus, the recovered clock signals S_{CLK,A}, S_{CLK,B} exhibit smaller fluctuations than in the case of FIG. 7.

In order to maximize the relative beat amplitude, the intensity of the auxiliary light AUX may be adjusted to be substantially at the same level as the intensity of the output signal S_{OUT} at each sideband frequency.

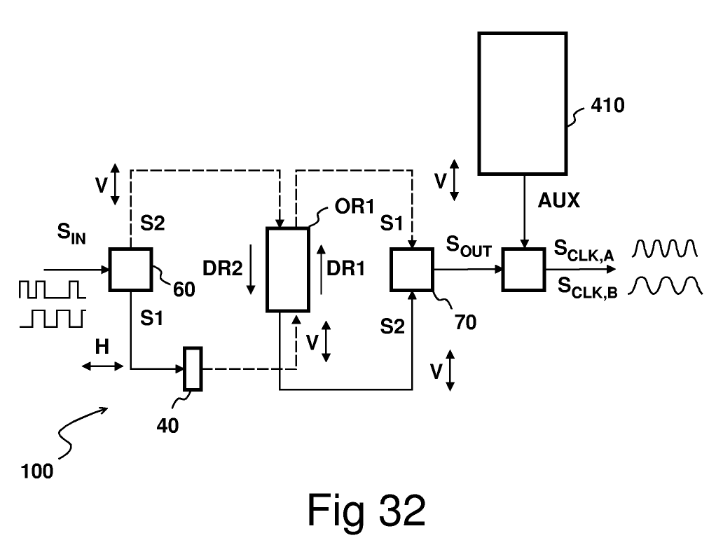

Referring to FIG. 32, the auxiliary light may be provided by one or more auxiliary light sources 410. The auxiliary light AUX is combined with the output S_{OUT} of the clock recovery device 100 by a combiner 70 in order to form an output which comprises the recovered the clock signals S_{CLK,A}, S_{CLK,B}. The auxiliary light source 410 may be a laser which is accurately stabilized. The laser may be stabilized e.g. by spectrally locking it to one or more spectral peaks of the input signal S_{IN}. Alternatively, the transmitting unit 200 (FIGS. 8 and 30) may be spectrally locked with the auxiliary light source 410.

The clock recovery devices 100 described with reference to FIGS. 11 to 22 and the embodiments according to FIGS. 23-30 may be used in combination with the auxiliary light (AUX).

The clock recovery device 100 may be used in combination with optical data receivers, repeaters, transponders or other type of devices used in fiber optic networks. The clock recovery device 100 may also be used in combination with optical data receivers, repeaters, transponders or other type of devices used in optical communication systems operating in free air or in space.

Referring back to FIG. 1, the transmitting unit 200 may be a transmitter of a point-to-point communication system. The receiving unit 400 may be a receiver of a point-to-point communication system 500. The transmitting unit 200 or the receiving unit 400 may be a part of a network node in a communication system 500. The transmitting unit 200 or the receiving unit 400 may be a of a part of a signal repeater, which is adapted to restore the optical signal S_{IN} in long distance communication systems. The transmitting unit 200 or the receiving unit 400 may be a part of a cross-connect, i.e. a circuit switch operating in the electrical domain or in the optical domain. The transmitting unit 200 and/or the receiving unit 400 may be a part of a router adapted to forward data packets in electrical or optical domain. The transmitting unit 200 or the receiving unit 400 may be a part of a time division add-drop-multiplexer operating in the electrical or optical domain.

The optical transmission path 300 may be an optical fiber, an optical fiber network, light transmissive material, liquid, gas or vacuum. The transmission path 300 may be used for one-directional or two-directional communication.

The clock recovery device 100 may be implemented using fiber optic components. The clock recovery device 100 may be implemented using separate free-space optical components. The clock recovery device 100 may be implemented using photonic bandgap structures. The clock recovery device 100 may be implemented using nanophotonic structures which are adapted to sustain surface plasmons. The optical resonators OR1, OR2 may e.g. comprise a pair of dielectric-coated mirrors separated by a gas such as air, or vacuum. The cavity 7 of the optical resonators OR1, OR2 may comprise transparent dielectric liquid and/or solid material. The clock recovery device 100 may be implemented by methods of integrated optics on a solid-state substrate using miniaturized components. Indium phosphide (InP)-based components or integrated structures may be used. The clock recovery device 100 is understood to comprise optical paths between the optical components, said paths being implemented by free-space optical links, liquid or solid-state optical waveguides, and/or optical fibers. Polarization-maintaining fibers may be used to transmit light. The optical resonators OR1, OR2, the spectral separation unit 120 and/or further optical components may be implemented on the same substrate. The polarizing splitter 60 may be implemented also by combining a non-polarizing splitter with polarizers.

The clock recovery device 100 may further comprise light-amplifying means to amplify the optical input signals and/or output signals. The light amplifying means may be implemented by e.g. rare-earth doped materials or waveguides. The light amplifying means may be a semiconductor optical amplifier.

The clock recovery devices 100 described above may also comprise three or more optical resonators OR1, OR2 optically coupled in parallel in order to allow further freedom to select the spectral positions of the data signals S_{IN,A}, S_{IN,B}, S_{IN,C}, S_{IN,D}.

The clock recovery devices 100 described above may also be used to recover only one clock frequency from an input signal S_{IN} consisting of one data signal S_{IN,A} only.

For a person skilled in the art, it will be clear that modifications and variations of the devices and the method according to the present invention are perceivable. The particular embodiments described above with reference to the accompanying drawings are illustrative only and not meant to limit the scope of the invention, which is defined by the appended claims.

1-32. (canceled)

33. A method of recovering two or more optical clock signals from an optical input signal, said input signal comprising several spectrally separate data signals, said method comprising:
dividing said input signal into a first polarized signal and a second polarized signal, the initial polarization state of said first polarized signal being different from the initial polarization state of said second polarized signal;
altering the polarization state of one or both of said first and second polarized signals such that the polarization state of said first polarized signal becomes the same as the polarization state of said second polarized signal;
directing the first polarized signal and the second polarized signal after said altering of the polarization state or states to pass through one or more optical resonators in opposite directions, said one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal; and
combining said first polarized signal and said second polarized signal after passing through said one or more optical resonators in order to form an output signal comprising a first recovered clock signal having said first clock frequency and a second recovered clock signal having said second clock frequency.

34. The method according to claim 33, further comprising:
rotating the polarization of one or both of said first and second polarized signals after passing through said optical resonators such that the polarization of said first polarized signal is perpendicular to the polarization of said second polarized signal before said combining.

35. The method according to claim 33, wherein said first spectral peak corresponds to a carrier frequency of a data signal, and said second spectral peak corresponds to a sideband frequency of said data signal.

36. The method according to claim 33, wherein said first spectral peak corresponds to a first sideband frequency of the optical input signal, and said second spectral peak corresponds to a second sideband frequency of a carrier-suppressed optical input signal.

37. The method according to claim 33, wherein at least two data signals of said input signal have different clock frequencies.

38. The method according to claim 33, further comprising:
separating clock signals spatially from said output signal.

39. The method according to claim 33, wherein the time constant of said one or more optical resonators is greater than or equal to an average time period during which the input signal does not change its logical state.

40. The method according to claim 33, further comprising:
stabilizing the amplitude of the beat of at least one of said recovered clock signals.

41. The method according to claim 33, wherein at least one of said data signals is amplitude-modulated.

42. The method according to claim 33, wherein at least one of said data signals is phase-modulated.

43. The method according to claim 33, further comprising:
stabilizing at least one of said passbands spectrally with respect to said first spectral peak.

44. The method according to claim 33, further comprising:
monitoring the spectral position of said first spectral peak with respect to the spectral position of one of said passbands;
sending control information to an optical transmitting unit based on said spectral position; and
adjusting said optical transmitting unit spectrally on the basis of said control information.

45. The method according to claim 33, further comprising:
generating said second spectral peak based on an optical primary signal.

46. The method according to claim 45, wherein said second spectral peak is generated by nonlinear optical device.

47. The method according to claim 45, wherein said primary signal is modulated according to the non-return-to-zero format.

48. A clock recovery device for recovering two or more clock signals from an optical input signal, said input signal comprising two or more spectrally separate data signals, said clock recovery device comprising:
a polarizing splitter to divide an input signal into a first polarized signal and a second polarized signal, the initial polarization state of said first polarized signal being different from the initial polarization state of said second polarized signal;
one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal;
one or more polarization altering member configured to alter the polarization state of one or both of said polarized signals such that the polarization state of said first polarized signal becomes the same as the polarization state of said second polarized signal, said first and second polarized signals being after said altering of the polarization state or states adapted to pass through said one or more optical resonators in opposite directions; and
a combiner to combine said first signal and said second signal after passing through said one or more optical resonators in order to form an output signal comprising a first recovered clock signal having said first clock frequency and a second recovered clock signal having said second clock frequency.

49. The clock recovery device according to claim 48, wherein said polarizing splitter is adapted to act as said combiner.

50. The clock recovery device according to claim 48, wherein said polarization rotator is adapted to rotate the polarization of said first polarized signal substantially 90 degrees.

51. The clock recovery device according to claim 50, further comprising:
a further polarization rotator to rotate said first polarized signal and said second polarized signal substantially 45 degrees; and
a Faraday rotator to rotate said first polarized signal and said second polarized signal substantially 45 degrees.

52. The clock recovery device according to claim 48, further comprising:
an optical circulator to separate the recovered clock signals from said input signal.

53. The clock recovery device according to claim 48, wherein at least one of said optical resonators comprises an optical cavity defined by at least two reflectors.

54. The clock recovery device according to claim 48, wherein at least one of said optical resonators comprises periodic structures.

55. The clock recovery device according to claim 48, wherein at least one of said optical resonators is a micro ring resonator, a sphere resonator, or a toroid resonator.

56. The clock recovery device according to claim 48, wherein at least one of said optical resonators comprises birefringent medium.

57. The clock recovery device according to claim 48, wherein the separation range of at least one of said optical resonators is adjustable.

58. The clock recovery device according to claim 48, wherein said polarizing splitter is a combination of a non-polarizing splitter and two polarizers.

59. The clock recovery device according to claim 48, further comprising:
a stabilization unit to stabilize the beat amplitude of at least one of said recovered clock signals.

60. The clock recovery device according to claim 59, wherein said stabilization unit comprises a component selected from among a semiconductor optical amplifier, an optically saturable element, and an optical resonator exhibiting optical bistability.

61. The clock recovery device according to claim 48, further comprising:
integrated optics configured to at least partially recover the at least two clock signals.

62. The clock recovery device according to claim 61, wherein the integrated optics comprise indium phosphide technology or fused silica technology.

63. An optical communication system, comprising:
a transmitter configured to send an optical input signal, said input signal comprising two or more spectrally separate data signals;
a transmission path;
a receiver; and
a clock recovery device to recover at least two clock signals from said optical input signal, said clock recovery device comprising
a polarizing splitter to divide an input signal into a first polarized signal and a second polarized signal, the initial polarization state of said first polarized signal being different from the initial polarization state of said second polarized signal,
one or more optical resonators having a plurality of passbands, a first passband being matched with a first spectral peak of said input signal, a second passband being matched with a second spectral peak of said input signal, a third passband being matched with a third spectral peak of said input signal, and a fourth passband being matched with a fourth spectral peak of said input signal such that the spectral separation between said first spectral peak and said second spectral peak is equal to a first clock frequency associated with said input signal, and such that the spectral separation between said third spectral peak and said fourth spectral peak is equal to a second clock frequency associated with said input signal,
one or more polarization altering member configured to alter the polarization state of one or both of said polarized signals such that the polarization state of said first polarized signal becomes the same as the polarization state of said second polarized signal, said first and second polarized signals being after said altering of the polarization state or states adapted to pass through said one or more optical resonators in opposite directions, and
a combiner to combine said first signal and said second signal after passing through said one or more optical resonators in order to form an output signal comprising a first recovered clock signal having said first clock frequency and a second recovered clock signal having said second clock frequency.

64. A method of recovering two or more optical clock signals from an optical input signal, said input signal comprising several spectrally separate data signals, said method comprising:
dividing said input signal into a first polarized signal and a second polarized signal, the initial polarization state of said first polarized signal being different from the initial polarization state of said second polarized signal;
altering the polarization state of one or both of said first and second polarized signals such that the polarization state of said first polarized signal becomes the same as the polarization state of said second polarized signal;
directing said first polarized signal and said second polarized signal after said altering of the polarization state or states to pass through one or more optical resonators in opposite directions, said one or more optical resonators having passbands, a first passband being matched with a first spectral peak of said input signal, and a second passband being matched with a second spectral peak of said input signal;
combining said first polarized signal and said second polarized signal after passing through said one or more optical resonators in order to form an output signal;
combining said output signal with auxiliary light having a third spectral peak and a fourth spectral peak such that a first clock signal and a second clock signal are formed, the spectral separation between said first spectral peak and said third spectral peak being equal to a first clock frequency associated with said input signal, and the spectral separation between said second spectral peak and said fourth spectral peak being equal to a second clock frequency associated with said input signal.

65. The method according to claim 64, wherein said auxiliary light is provided by one or more lasers.
